(19) United States
(12) Patent Application Publication
(10) Pub. No.: US 2003/0146141 A1
(43) Pub. Date: Aug. 7, 2003

(54) Agitated counter current flotation apparatus

(76) Inventor: John C. Schneider, St. Andrews (CA)

Correspondence Address: WEINGARTEN, SCHURGIN, GAGNEBIN & LEBOVICI LLP, TEN POST OFFICE SQUARE, BOSTON, MA, 02109, US

(21) Appl. No.: 10/068,805

(22) Filed: Feb. 6, 2002

(51) Int. Cl. C02F 1/24

(52) U.S. Cl. 210/221.1

(57) ABSTRACT

The invention is an agitated countercurrent flotation apparatus having a plurality of flotation cells through which a separable fluid mixture of solids or liquids or both flows sequentially. Preferably, each cell is provided with an upright shaft having a plurality of impellers attached to it and spaced along its length with disks being affixed to the shaft between adjacent impellers, thereby defining a plurality of flotation zones vertically within the cell. This structure enables the creation of a gradient of flotation conditions vertically within each cell so that conditions can be tailored to maximize the mass transfer of particles onto bubbles and promote a flow of liquids or solids laden bubbles upward through the cell and a countercurrent decreasing concentrated stream for the feed into the next cell. The separation efficiency of the flotation process provided by the apparatus is enhanced by providing each cell with an overflow launder into which a liquids or solids laden froth flows, and providing fluid communication means extending from the overflow launder of each downstream cell to an inlet of the previous upstream cell, thereby providing a recycling of floated material. The apparatus is particularly useful for the flotation of fine and ultrafine particles.

### BACKGROUND OF THE INVENTION

The invention is a device for the separation of particles or fluids of interest suspended as a mixture in a fluid medium in accordance with the various flotation characteristics of the particles or fluids or both.

Flotation cells have been used in industry for many years, particularly in the mining industry where aqueous slurries of crushed ore are subjected to flotation for the purpose of separating mineral bearing particles from gangue. In a typical flotation separation process carried out in a tank or cell, bubbles and slurried particles must come into contact so that particles of interest are selectively attached to the bubbles through attractive forces provided by the compositions of the bubbles and the particles. In a successful flotation process, particles of interest must have sufficient residence time on the bubbles to allow the rising bubbles to transport such particles out of the flotation cell. Depending on the nature of the particles to be floated, large to small bubbles with specific dynamic conditions may be preferred, and a shallow or deep froth zone may be most suitable at the top of the cell. In fact, there are many parameters which may be varied in a typical flotation application, but heretofore it has not been possible to actively control all these variables so as to optimize flotation efficiency for a given application.

The efficiency of a flotation process depends on the ability of particles of interest to attach to and remain on a rising flow of bubbles until the particle laden bubbles can be removed from the apparatus. In a hydrometallurgical application, particle sizes may vary as an approximation from fine (<6 microns) to intermediate (6-60 microns) to coarse (>60 microns), and typically each of these particle size ranges are optimally recovered under a different set of controlling parameters. For example, the weak forces of attachment of a particle to a bubble make the flotation of coarse particles inefficient relative to intermediate sized particles because the particles tend to fall off the bubbles and relatively large bubbles are required in order to effect flotation. Thus, low agitation conditions are generally preferred for the flotation of coarse particles. On the other hand, without agitation fine particles have difficulty penetrating the liquid film surrounding a bubble in order to form a firm attachment to the bubble. Because fines have a large surface area compared to their weight, fine particles tend to load onto small bubbles to the saturation capacity of the bubbles without providing a high loading as measured by grams/liter of gas when compared to intermediate or coarse particles. Accordingly, most flotation processes are designed to separate intermediate sized particles (6-60 microns), which are the easiest to float, with the fines being lost to the tailings and the coarse particles being reprocessed to reduce their size.

The invention provides an apparatus which has the versatility to allow the operator to adjust the various flotation parameters to enable the flotation of particles or fluids of interest from fine or ultrafine (i.e. <2 microns) to coarse particles. As mentioned, the flotation of fine or ultrafine particles poses particular difficulties due to the energy required to contact the particles with the bubbles and the subsequent low loading (mass/unit volume) of particles onto the bubbles. In contrast to the situation where intermediate sized ore particles are floated at a gas loading density on the order of 200 grams/liter, an efficient flotation process for fine ore particles provides a gas loading density on the order of 5 grams/liter. The situation is even more extreme in relation to the floating of ultrafine particles such as ink particles in a paper de-inking process. The loading of ink particles onto bubbles is typically provided at a density on the order of 0.05 grams/liter.

The present invention particularly addresses the challenges associated with the flotation of fine and ultrafine particles by providing an apparatus having a plurality of flotation cells, each of which constitutes a countercurrent contacting apparatus, with each of the cells being in serial countercurrent communication through which a slurry flows from a first inflow cell to a final outflow cell. Preferably, each cell is provided with an upright shaft having a plurality of impellers attached to it and spaced along its length with disks being affixed to the shaft between adjacent impellers, thereby defining a plurality of flotation zones vertically within the cell. This structure enables the creation of a gradient of countercurrent flotation conditions vertically within each cell so that conditions can be tailored to maximize the mass transfer of particles onto bubbles and to promote a flow of particle laden bubbles upward through the cell. The separation efficiency of the flotation process provided by the apparatus is enhanced in accordance with the present invention by providing each cell with an overflow launder into which a particles laden froth flows, and providing fluid communication means extending from the overflow launder of each downstream cell to an inlet of the previous upstream cell, thereby providing a recycling of floated material for further processing and improvement of grade.

Pursuant to the following description, the skilled person will appreciate that with modified operating conditions, the invention can be equally effective for use in flotation processes involving coarse or intermediate sized particles.

### BRIEF DESCRIPTION OF THE DRAWINGS

FIG. 1 is a perspective, partially broken away, view of a preferred embodiment of the apparatus of the invention.

FIG. 2 is a cross-sectional view of a cell of the apparatus shown in FIG. 1.

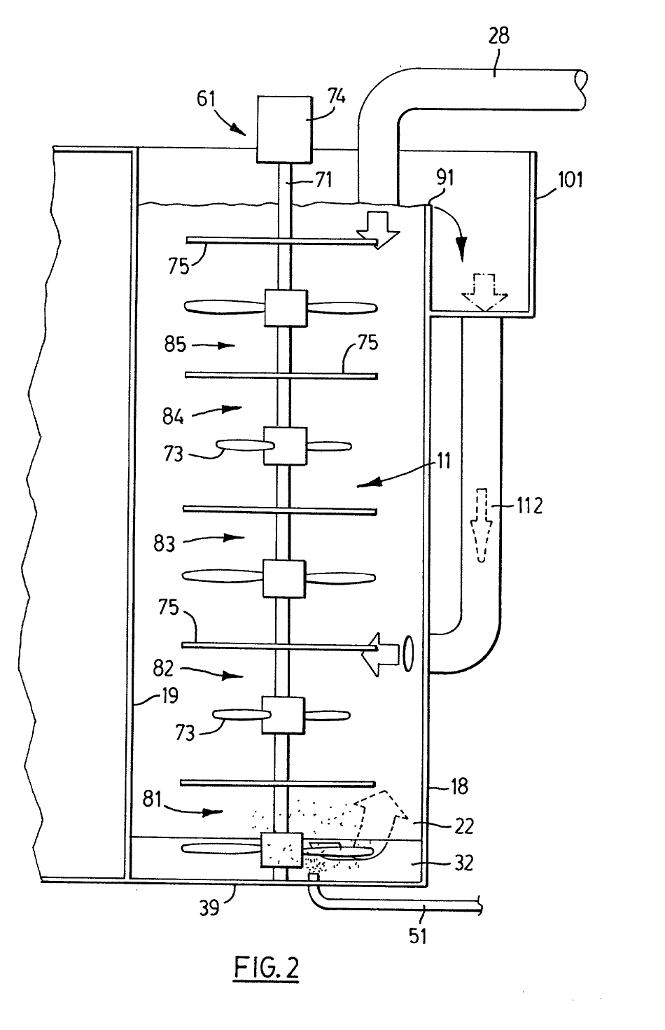

### DETAILED DESCRIPTION OF THE PREFERRED EMBODIMENT

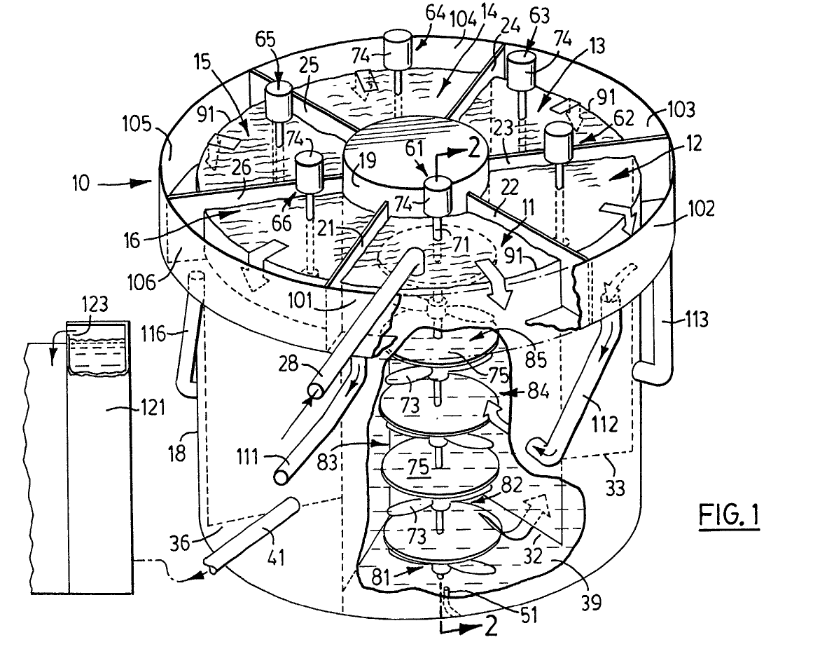

The operation of an apparatus of the invention will be described in the context of its use in a paper de-inking process. The apparatus 10 of the invention preferably comprises an annular array of flotation cells 11-16 through which a slurry flows in a sequential manner. The shape of the apparatus 10 is not essential so long as a series fluid flow from cell to cell can be achieved. An annular array of cells is merely convenient for many applications. As shown in FIG. 1, the cells 11-16 are defined by an outer wall 18, an inner wall 19, and interior walls 21-26.

A liquid slurry of particles to be separated enters the apparatus at the first cell 11 through an inlet pipe 28. The slurry proceeds through the cells 11-16 in a sequential fashion by flowing through openings 32-36 defined in cell walls 22-26. Preferably, the openings 32-36 are located directly above the bottom 39 of the apparatus 10. The openings 32-36 are sized in accordance with the desired flow rate for the slurry through the apparatus 10 and the desired pressure drop across the cells of the apparatus. The slurry exits the apparatus through an outlet pipe 41 preferably extending from a lower portion of the final cell 16. There is no direct fluid flow communication between the cells 11 and 16, as the cell wall 21 separating those two cells has no opening through it.

Flotation is provided in each cell 11-16 by introducing compressed air into the lower portion of each cell 11-16 through inlet pipes 51-56 which may be equipped with spargers, and which preferably extend through the bottom 39 of each cell. In most applications, each cell 11-16 is also provided with mechanical agitation means 61-66. The flow of compressed air into each cell 11-16 may be controlled to provide an optimal air volume suitable to the target particle being floated in the cell. As illustrated in relation to the first cell 11, the agitation means 61 comprises an upright shaft 71 having a plurality of impellers 73 attached to it at spaced intervals along the shaft 71. Each shaft 71 is preferably driven by a variable speed motor 74. In the preferred embodiment shown, the shaft 71 is provided with five impellers 73, but the number of impellers used will be dependent on the nature of the particles being separated, and therefore, the number of vertical stages needed to provide the optimal result. A disk 75 is provided between each pair of adjacent impellers 73 and above the top impeller 73, thereby defining five vertical flotation zones 81-85 within the cell 11. The impellers 73 may have varying structures to provide different agitation conditions in each zone 81-85.

The mechanical agitation means 61-66 coact with inflowing compressed air to generate a vertical countercurrent fluid flow of flotation froth and slurry in each cell 11-16. This combination of mechanical agitation and compressed air inflow allows for the control of bubble forming conditions within the slurry so that the desired bubble size and froth makeup can be achieved within each cell 11-16 to provide optimum operating conditions. The agitators 61-66 provide a mechanical force to move particles in the slurry through the bubble boundary layer so that the particles can attach to the bubbles. It is particularly important to provide this mechanical force to promote the attachment of ultrafine ink particles to bubbles in a paper de-inking process. The staging provided by the impellers 73 and disks 75 promotes a flow of particle-laden bubbles up the column of each cell 11-16. The design and operation of each impeller 73 on the mechanical agitators 61-66 is geared to maximize the mass transfer of particles onto the bubbles generated, and the upward air flow combined with the speed of the agitators 61-66 determines the residence time of bubbles in each stage 81-85.

In some applications sufficient agitation may be provided in each cell solely by the inflow of compressed air. For example, the separation of fluids may require the gentler agitation conditions provided by compressed air only. Other applications may require a single mechanical agitator in each cell to coact with inflowing compressed air to provide agitation. The scope of the invention is intended to include those means for providing agitation in each cell ranging from the simple inflow of compressed air to the multi-zone mechanical agitation means such as described above. The skilled person will appreciate that various agitation means can provide the desired vertical countercurrent fluid flow in each cell, and specific agitation conditions will be dictated by the nature of the separation being undertaken.

The froth formed in each cell 11-16 overflows a top spillway lip 91 of the outer cylindrical wall 18 of the apparatus 10 into a launder 101-106. Upon entering a launder 101-106, the froth quickly collapses to a liquid slurry which proceeds through a drain 111-116 provided in each launder 101-106. Each launder 101-106 may be provided with a high-pressure water spray (not shown) to break down the froth and to clean off particles from launder surfaces. In a paper de-inking process, the slurry from the launder 101 of the first cell 11 contains the greatest concentration of ink particles in relation to the slurries formed in the remaining launders 102-106. Accordingly, the slurry drained from the launder 101 through the drain pipe 111 constitutes the rejects stream for the slurry mixture processed by the apparatus 10. In a de-inking process, the froth spilling over the lip 91 of each cell 11-16 will contain a concentration of paper fibers which ideally should be recovered. Accordingly, the apparatus 10 provides for a recycling of froth exiting each cell 12-16 to the previous upstream cell 11-15 by connecting each downstream launder drain pipe 112-116 to the previous upstream cell 11-15 as shown in FIG. 1. Preferably, each drain pipe 112-116 connects to the previous upstream cell 11-15 approximately midway along its height. Because the froth entering each launder rapidly collapses to a liquid slurry, it is more dense than the aerated fluid in a cell, so it may be readily recycled through a drain into a region midway or higher in the previous upstream cell.

As used in a de-inking process, the ultrafine particles of ink are floated in preference to the more hydrophilic paper fibers which tend to move with the slurry from cell to cell through the lower openings 32-36. Accordingly, the paper fibers become progressively cleaner as they move through the cells 11-16 by virtue of the multistage design on the apparatus 10 in conjunction with the recycling of the overflow froth from each downstream cell 12-16 to the previous upstream cell 11-15.

The flow of slurry from cell to cell through the apparatus 10 is driven by the fluid pressure provided by the inflow of slurry through the inlet pipe 18 and by the velocity head provided by the lowest impeller 73 in each cell. The fluid level in the apparatus 10 is preferably governed by a standpipe 121 connected to the outlet pipe 41 extending from a lower portion of the last cell 16. The standpipe 121 is equipped with an adjustable weir 123 over which the processed slurry spills. By adjusting the height of the weir 123, the fluid level in the apparatus 10 may be adjusted, and thereby, the layer of froth atop each cell 11-16 may be made thicker or thinner in accordance with desired operating conditions.

From the foregoing description, the skilled person will appreciate that the invention possesses a high degree of versatility and may be adapted to a wide variety of applications. Accordingly, the description herein is not intended to limit the scope of protection afforded to the invention as defined in the following claims.

1. An agitated countercurrent flotation apparatus for the separation of solids or liquids or both suspended as a separable mixture, in a fluid medium, comprising:
a serial array of flotation cells each having upstanding walls and a floor, which cells are in serial fluid flow communication from the first inflow cell to a final outflow cell so that a separable mixture may flow sequentially from cell to cell through the apparatus, the first cell having fluid inlet means for introducing a feed of separable mixture containing floatable liquids or solids into the apparatus and the final cell having fluid outlet means for removing processed mixture from the apparatus, the serial fluid flow from the first cell to the final cell being provided by an opening in a lower portion of each common wall between adjacent cells;
air inlet means positioned in a lower region of each cell for introducing and controlling compressed air into each cell, so that a countercurrent flow of fluids is provided vertically within each cell;
an overflow launder for each cell for accepting a liquids or solids laden froth generated in each cell; and
fluid communication means extending from the overflow launder of each cell downstream from the first inflow cell to an inlet of the previous upstream cell thereby providing a means for recycling floated material so as to increase the efficiency of the materials separation being sought.

2. An apparatus as claimed in claim 1, wherein the serial array of flotation cells consists of at least six cells.

3. An apparatus as claimed in claim 1, wherein the serial array of flotation cells is annular having a common outer peripheral wall with an upper spillway lip for each cell.

4. An apparatus as claimed in claim 1, wherein the air inlet means is a pipe extending through the floor of each cell.

5. An apparatus as claimed in claim 4, wherein the air inlet means if an air distributor.

6. An apparatus as claimed in claim 4, wherein the pipe is positioned beneath the mechanical agitation means for the cell.

7. An apparatus as claimed in claim 1, wherein each overflow launder receives a liquids or solids laden froth over an upper lip of a cell wall.

8. An apparatus as claimed in claim 3, wherein the launders are positioned about the upper outer peripheral wall, and each launder receives a liquids or solids laden froth over the upper spillway lip.

9. An apparatus as claimed in claim 1, wherein the fluid communication means is a pipe draining from said overflow launder into the previous upstream cell.

10. An apparatus as claimed in claim 9, wherein the pipe is connected into the previous upstream cell at a region approximately midway along its height.

11. An agitated countercurrent flotation apparatus for the separation of solids or liquids or both suspended as a separable mixture, in a fluid medium, comprising:
a serial array of flotation cells each having upstanding walls and a floor, which cells are in serial fluid flow communication from the first inflow cell to a final outflow cell so that a separable mixture may flow sequentially from cell to cell through the apparatus, the first cell having fluid inlet means for introducing a feed of separable mixture containing floatable liquids or solids into the apparatus and the final cell having fluid outlet means for removing processed mixture from the apparatus, the serial fluid flow from the first cell to the final cell being provided by an opening in a lower portion of each common wall between adjacent cells;
air inlet means positioned in a lower region of each cell for introducing and controlling compressed air into each cell;
mechanical agitation means for each cell comprising an upright shaft having a plurality of impellers attached to it and spaced along its length with disks being affixed to the shaft between adjacent impellers, thereby defining a plurality of flotation zones vertically within each cell, the air inlet and mechanical agitation means coacting to provide a countercurrent fluid flow vertically within each cell;
means for rotating and controlling the speed of the shaft;
an overflow launder for each cell for accepting a liquids or solids laden froth generated in each cell; and
fluid communication means extending from the overflow launder of each cell downstream from the first inflow cell to an inlet of the previous upstream cell thereby providing a means for recycling floated material so as to increase the efficiency of the materials separation being sought.

12. An apparatus as claimed in claim 11, wherein the serial array of flotation cells consists of at least six cells.

13. An apparatus as claimed in claim 11, wherein the serial array of flotation cells is annular having a common outer peripheral wall with an upper spillway lip for each cell.

14. An apparatus as claimed in claim 11, wherein the air inlet means is a pipe extending through the floor of each cell.

15. An apparatus as claimed in claim 14, wherein the air inlet means is an air distributor.

16. An apparatus as claimed in claim 14, wherein the pipe is positioned beneath the mechanical agitation means for the cell.

17. An apparatus as claimed in claim 11, wherein the mechanical agitation means defined at least three flotation zones vertically within each cell.

18. An apparatus as claimed in claim 11, wherein the means for rotating and controlling the speed of the shaft is a motor.

19. An apparatus as claimed in claim 18, wherein a motor is a variable speed motor.

20. An apparatus as claimed in claim 11, wherein each overflow launder receives a liquids or solids laden froth over an upper lip of a cell wall.

21. An apparatus as claimed in claim 13, wherein the launders are positioned about the upper outer peripheral wall, and each launder receives a liquids or solids laden froth over the upper spillway lip.

22. An apparatus as claimed in claim 11, wherein the fluid communication means is a pipe draining from said overflow launder into the previous upstream cell.

23. An apparatus as claimed in claim 22, wherein the pipe is connected into the previous upstream cell at a region approximately midway along its height.
